(19) United States
(12) Patent Application Publication
(10) Pub. No.: US 2008/0295031 A1
(43) Pub. Date: Nov. 27, 2008

(54) IMAGING APPARATUS AND IMAGE REPRODUCING DISPLAY DEVICE

(75) Inventor: Takao MIYAZAKI, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/865,187

(22) Filed: Oct. 1, 2007

(30) Foreign Application Priority Data
Sep. 29, 2006 (JP) 2006-267016

(51) Int. Cl. G06F 3/048; G06F 17/30; G06F 7/06

(52) U.S. Cl. 715/835; 707/100; 707/E17.031; 707/E17.008

(57) ABSTRACT

A digital camera records image files time-sequentially on a memory card. When an image sort-out button is pressed, an event delimiter file is recorded behind the latest image file, separate those image files recorded before the event delimiter file from image files recorded thereafter. Thus, image files recorded between one event delimiter file and a next event delimiter file are sorted into a group. Information on a group of image files delimited by the event delimiter file, including the date and time of shooting and GPS information, are read out from tag information of the respective image files, and recorded in the event delimiter file. When the memory card is set in a personal computer that is pre-installed with a specific software program, the event delimiter file is detected one after another, to display all images of the same group in a matrix on a screen.

### FIELD OF THE INVENTION

The present invention relates to an imaging apparatus that takes images through an image sensor and records the images in the form of digital image data in storage media while sorting the images into groups. The present invention also relates to an image reproducing display device for reproducing images from the image data recorded in the storage media by the imaging device, to display the images in groups as sorted by the imaging device.

### BACKGROUND OF THE INVENTION

Imaging apparatuses, such as digital cameras and camera phones, have been popular these days, which photoelectrically convert an optical image of a subject into an image signal through an image sensor, like CCD or CMOS, and convert the image signal into digital image data to record the image data on a storage medium like a memory card. Memory cards initially had a memory capacity of around 8 MB to 64 MB, but now, most memory cards have a memory capacity of 256 MB to 1 GB. So each memory card can store a huge number of image data files. As a result, however, it is getting harder to sort out and organize the images stored in the memory card.

In order to facilitate organizing the stored images, an image recording reproducing apparatus has been suggested for example in JPA Hei 07-123307, wherein information on the date and time and/or the place of shooting an image are attached to the image data of that image when the image data is recorded, so that the image data are automatically sorted out on the basis of the attached information. Thus, the images sorted in this way are displayed in groups on a display screen, providing an electronic album.

Because the image data are automatically sorted out on the basis of the attached tag information, the above-mentioned prior image recording reproducing apparatus reduces labor of the user. However, there may be cases where the automatic sorting does not fit the user's expectation. For example, the user may want to sort those images into the same group which were taken on different days but at the same place, or may want to sort even those images which were taken at the same place into different groups as they were taken at different times. Therefore, not a few users want to decide by themselves how to group the taken images.

### SUMMARY OF THE INVENTION

In view of the foregoing, a primary object of the present invention is to provide an imaging apparatus that allows the user to decide how to sort the taken images into groups on recording the images on a storage medium. Another object of the present invention is to provide an image reproducing display device that reproduces the images recorded on the storage medium by the imaging apparatus of the invention, so as to display the images in groups in the way as sorted by the imaging apparatus.

The present invention suggests an imaging apparatus that obtains an image signal from an optical image through an image sensor and converts the image signal into digital image data, the imaging apparatus comprising a device for recording the image data on a storage medium; a device for forming a delimiter file in response to a predetermined operation on an operating member, the delimiter file indicating that those image data recorded before the predetermined operation are separated from image data recorded after the predetermined operation; and a device for recording the delimiter file on the storage medium.

The delimiter file preferably holds information on the date and time and/or a geographic position at which the delimiter file was formed. The delimiter file is preferably a text file, and more preferably an HTML file. The delimiter file preferably holds link information, wherein if there is not another delimiter file on the storage medium, the link information informs that all image data recorded before the predetermined operation belong to the same group, and if any other delimiter files are already recorded before the predetermined operation, the link information informs that image data recorded after the latest one of the already recorded delimiter files till the predetermined operation belong to the same group.

The present invention also suggests an imaging apparatus that comprises a device for attaching tag information to image data of each image to form an image file and recording the image file on a storage medium; a device for forming a delimiter file in response to a predetermined operation on an operating member, the delimiter file indicating that those image files recorded before the predetermined operation are separated from ones recorded after the predetermined operation, wherein the tag information of all image files formed before the predetermined operation are recorded in the delimiter file if there is not another delimiter file on the storage medium, and that if other delimiter files are already recorded before the predetermined operation, the tag information of those image files formed after the latest one of the already recorded delimiter files till the predetermined operation are recorded in the delimiter file; and a device for recording the delimiter file on the storage medium.

The tag information preferably includes information on the date and time and/or a geographic position at which the individual image file was formed. The information on the geographic position may be latitude and longitude of the geographic position and/or a place name determined by the latitude and longitude. The latitude and longitude may be detected through a GPS (global positioning system) device that receives electric waves from many GPS satellites.

The present invention further suggests an imaging apparatus that obtains an image signal from an optical image through an image sensor and converts the image signal into digital image data, the imaging apparatus comprises a device for recording the image data on a storage medium; a device for forming a new folder in the storage medium in response to a predetermined operation on an operating member; and a device for transferring those image data, which have been recorded on the storage medium but not yet been stored in any folder, into the new folder.

Preferably, the imaging apparatus further comprises a device for forming a text file in the storage medium and recording link information in the text file when the image data are transferred to the new folder. The link information informs that the image data transferred to the new folder belong to the same group.

In order to reproduce images from image data recorded on a storage medium by the imaging apparatus of the present invention, the present invention suggests an image reproducing display device that comprises a device for detecting if any delimiter files are recorded on the storage medium, wherein the delimiter file indicates that those image data recorded in a time period before the delimiter file are separated from image data recorded after the delimiter file. The image reproducing display device of the present invention further comprises a device for sorting those image data recorded before the first recorded one of the delimiter files into one group, and sorting those image data recorded in a time period between one delimiter file and a next delimiter file into one group if a number of the delimiter files are recorded on the storage medium; and a device for displaying a list of images in a matrix based on the image data of the same group.

On the assumption that a storage medium stores image files, each of which is formed by attaching tag information to image data of each image, the tag information including the date and time and/or a geographic position at which the image is obtained, and that the tag information of all image files recorded before a delimiter file are recorded in the delimiter file if the delimiter file is a first recorded one, or the tag information of those image files recorded in a time period from a preceding delimiter file to the delimiter file are recorded in the delimiter file if the delimiter file is recorded after the first, an image reproducing display device of the present invention comprises a device for detecting whether there are any delimiter files on the storage medium, and a device for displaying a list of images in a matrix on the basis of the image data of those image files whose tag information are recorded in the same delimiter file. The display device also displays the date and time and/or the geographic position relating to the displayed images on the basis of the tag information recorded in the same delimiter file.

Furthermore, the present invention suggests an image reproducing display device for reproducing images from image data recorded on a storage medium by an imaging apparatus that comprises a device for forming a new folder in the storage medium in response to a predetermined operation on an operating member, and a device for transferring those image data which have been recorded on the storage medium but not yet been stored in any folder, into the new folder. The image reproducing display device of this invention comprises a device for displaying a list of images in a matrix on a screen on the basis of the image data stored in the same folder.

According to one invention, the delimiter file is formed and recorded on the storage medium in response to the predetermined operation on the operating member, and the delimiter file indicates that those image data recorded before the predetermined operation are separated from image data recorded after the predetermined operation. According to the other invention, each time the predetermined operation on the operating member is made, a new folder is formed on the storage medium and the image data recorded after the preceding folder are transferred into the new folder. Thus, image data are sorted into a group by storing them in the same folder.

The user can make the predetermined operation at arbitrary timing, so the user can decide how to separate the images into groups. Recording the delimiter file with the information on the date and time and/or a geographic position, at which the delimiter file was formed, facilitates organizing the images afterward.

Forming the delimiter file as a text file saves the capacity of the storage medium. The text file may be a plan text, but preferably be an HTML file, because the HTML file enables displaying the content of the delimiter file in a user-friendly manner just by using specific software such as a Web browser to open the delimiter file. According to the embodiment where the ink information is recorded in the HTLM file, all images of the same group are displayed instantly if only the delimiter file is opened using the specific software such as a Web browser.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a perspective view showing an outer appearance of a digital camera embodying an imaging apparatus of the present invention;

FIG. 2 is a block diagram illustrating the circuitry of the digital camera of FIG. 1;

FIG. 3 is an explanatory diagram illustrating an example of an image file;

FIG. 4 is an explanatory diagram illustrating how event delimiter files are recorded in a folder to separate the image files into groups;

FIG. 5 is an explanatory diagram illustrating an example of the event delimiter file formed as a text file;

FIG. 6 is an explanatory diagram illustrating a schematic structure of a personal computer;

FIG. 7 is an explanatory diagram illustrating a page on a screen of an LCD, displaying thumbnails of a series of images delimited by the event delimiter file;

FIG. 8 is a flowchart illustrating a sequence of forming the event delimiter file in response to an operation on an image sort-out button;

FIG. 9 is a flowchart illustrating a sequence of displaying thumbnails of a series of images delimited by the event delimiter file;

FIG. 10 is an explanatory diagram illustrating an example of the event delimiter file formed as an HTML file;

FIG. 11 is an explanatory diagram illustrating a folder formed to hold a series of image files in response to an operation on an image sort-out button, according to another embodiment of the invention;

FIG. 12 is a flowchart illustrating a sequence of operation responsive to the operation on the image sort-out button;

FIG. 13 is a flowchart illustrating a sequence of displaying thumbnails of all images stored in the individual folder; and

FIG. 14 is an explanatory diagram illustrating a page on a screen of an LCD, displaying thumbnails of all images stored in the same folder.

### DESCRIPTION OF THE PREFERRED EMBODIMENTS

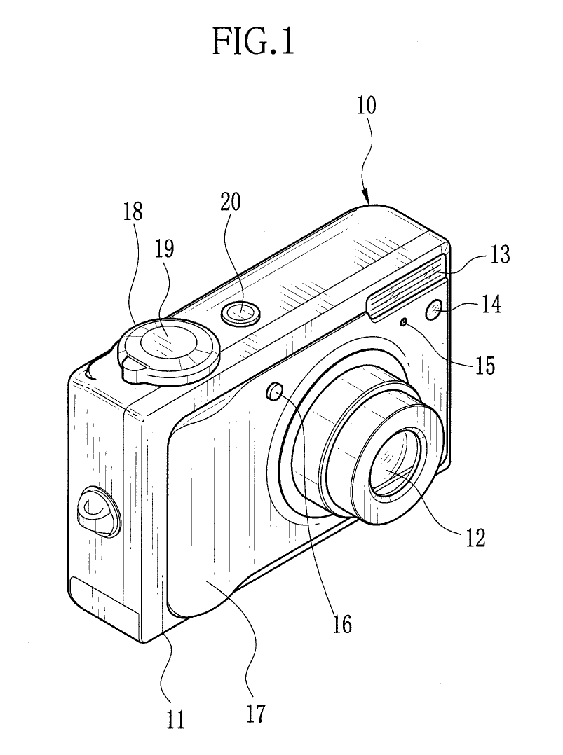

FIG. 1 shows a digital camera 10 embodying an imaging apparatus of the present invention. On front side of a camera body 11 of the digital camera 10, there are provided a collapsible taking lens 12, a flash projector 13, an auto-focus (AF) supplemental light projection window 14, a light control sensor 15, and an image sort-out button 16 that is essential to the present invention.

The image sort-out button 16 is located at a position that is convenient for the camera user to push it by the first or second finger of the right hand that is holding the camera body 11 at a grip portion 17. As will be described in detail later, each time the image sort-out button 16 is pushed down, a text file that delimits an event, hereinafter referred to as an event delimiter file, is produced in a memory card that is loaded in the digital camera 10 to record images taken by the digital camera 10. The event delimiter file separates images taken before the event delimiter file as a first image group from images taken after the event delimiter file. The images taken after the event delimiter file till a next event delimiter file are sorted into a second image group.

Note that the term “event” includes a lot of meanings in the present description. The events may represent arbitrary places that are decided by the camera user. For example, the event may represent a place where the camera user made a tour or took a series of images, as well as any events in general, e.g. parties, festivals and meetings. The event may also represent a time period while a series of images were taken. That is, the event may be arbitrarily decided by the camera user, so that the camera user can decide how to sort and group the images taken by the digital camera 10.

On top side of the camera body 11 are disposed a mode switching dial 18, which is a ring turned for switching imaging modes between an automatic mode, a manual mode and other modes, a shutter button 19 placed in the center of the mode switching dial 18 and a power button 20.

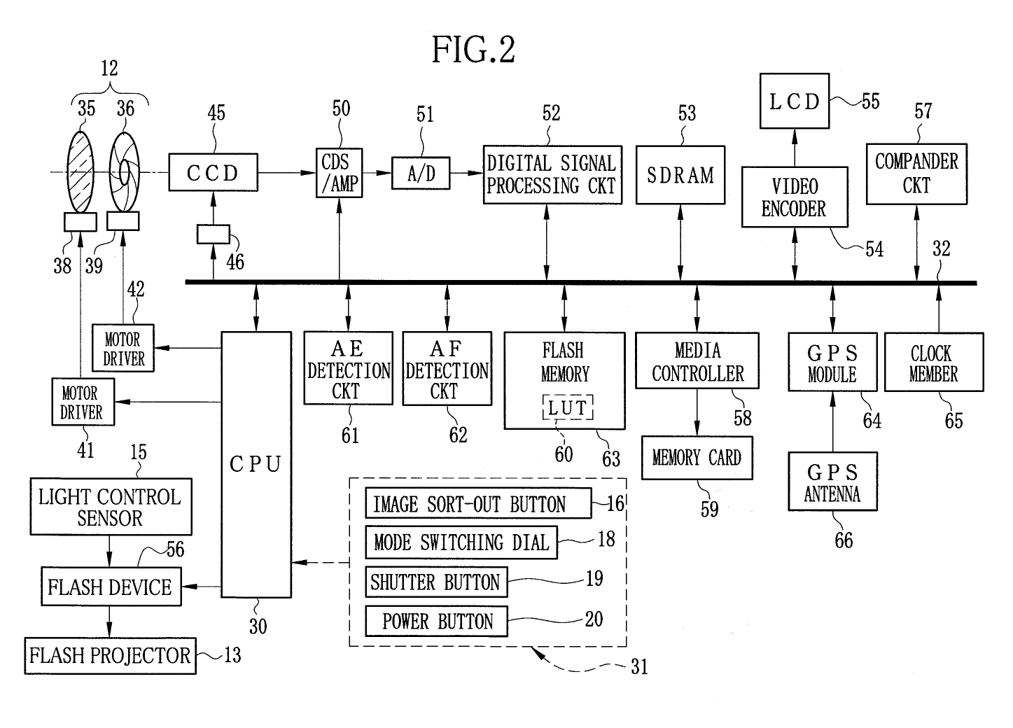

Referring to FIG. 2 showing the circuitry of the digital camera 10, a CPU 30 controls respective components of the digital camera 10 through a bus 32, in response to operational signals entered through an operating section 31. The operating section 31 includes the image sort-out button 16, the mode switching dial 18, the shutter button 19 and the power button 20.

The taking lens 12 consists of lens elements 35 and a stop 36. The lens elements 35 are driven by a lens drive mechanism 38 that includes a motor, to make focusing and zooming. The stop 36 is driven by a stop drive mechanism 39 that includes a motor, to change the aperture size. The drive mechanisms 38 and 39 are driven by motor drivers 41 and 42 under the control of the CPU 30.

A CCD 45 is disposed as an image sensor behind the taking lens 12. The CCD 45 is driven by a CCD driver 46. In the imaging mode, a moving image of a subject formed through the taking lens 12 on the CCD 45 is displayed as a camera-through image on an LCD 55 that is provided on rear side of the camera body 11, so the LCD 55 functions as an electronic viewfinder while displaying the camera-through image.

To display the camera-through image on the LCD 55, field image signals, i.e. image signals of even fields or odd fields, are read out from the CCD 45 and transferred to a CDS/AMP circuit 50. At a recording shot, image signals of one frame are read out from the CCD 45 and transferred to the CDS/AMP 50.

The CDS/AMP 50 consists of a correlated double sampling (CDS) circuit and an amplifier (AMP). The CDS circuit produces analog RGB signals, color separation signals of red, green and blue, from the image signals outputted from the CCD 45. The amplifier amplifies the analog RGB signals.

The amplified signals from the CDS/AMP 50 are converted through an A/D converter 51 to digital image data. The digital image data are processed in a digital signal processing circuit 52 for edge enhancement, median filtering, coring, white balance control and the like. To display the camera-through image, the processed image data are stored temporarily in an SDRAM 53, and then sent through a video encoder 54 to the LCD 55.

The LCD 55 also displays a preview image of an image frame just recorded on a memory card 59 or an image reproduced from image data read out from the memory card 59. If the image data outputted from the digital signal processing circuit 52 are for recording, i.e. obtained from the image signals of one frame, the image data are temporarily stored in the SDRAM 53, and then compressed in a compander circuit 57. The compressed image data are written in the memory card 59 through a media controller 58.

The bus 32 connects the digital signal processing circuit 52, the SDRAM 53, the video encoder 54, the compander circuit 57, and the media controller 58. The bus 32 also connects an AE detection circuit 61, an AF detection circuit 63, a flash memory 63, a GPS (global positioning system) module 64 and a clock member 65. The GPS module 64 is connected to a well-known GPS antenna 66.

The AE detection circuit 61 integrates luminance signals of the image signals, and sends an integrated luminance value as photometry data to the CPU 30. The CPU 30 judges by the photometry data whether the subject brightness under the natural light is sufficient. If not, the CPU 30 drives a flash device 56 to project flashlight from the flash projector 13. The flash device 56 decides to stop projecting the flashlight with reference to a signal fed from the light control sensor 15.

The AF detection circuit 62 decomposes the image signals into spatial frequency components, extracts high frequency components of the spatial frequency components, and sends contrast data of the high frequency components to the CPU 30. The CPU 30 controls the lens drive mechanism 38 through the motor driver 41 to move a focusing lens along an optical axis, and stop the focusing lens at a position where the contrast of the high frequency components of the image formed on the CCD 45 comes to be the highest.

The flash memory 63 is a well-known nonvolatile memory and stores a look-up table 60 showing a relationship between geographic positions and place names of the geographic positions, as set forth in detail later. The flash memory 63 also stores a variety of data, programs and control parameters.

The GPS module 64 communicates through the GPS antenna 66 with a number of GPS satellites, to obtain so-called GPS information, i.e. information on a geographic position of the digital camera 10, indicated by latitude and longitude of the geographic position. The GPS module 64 sends the GPS information to the CPU 30. The clock member 65 continuously clocks and sends information on the present date and time to the CPU 30.

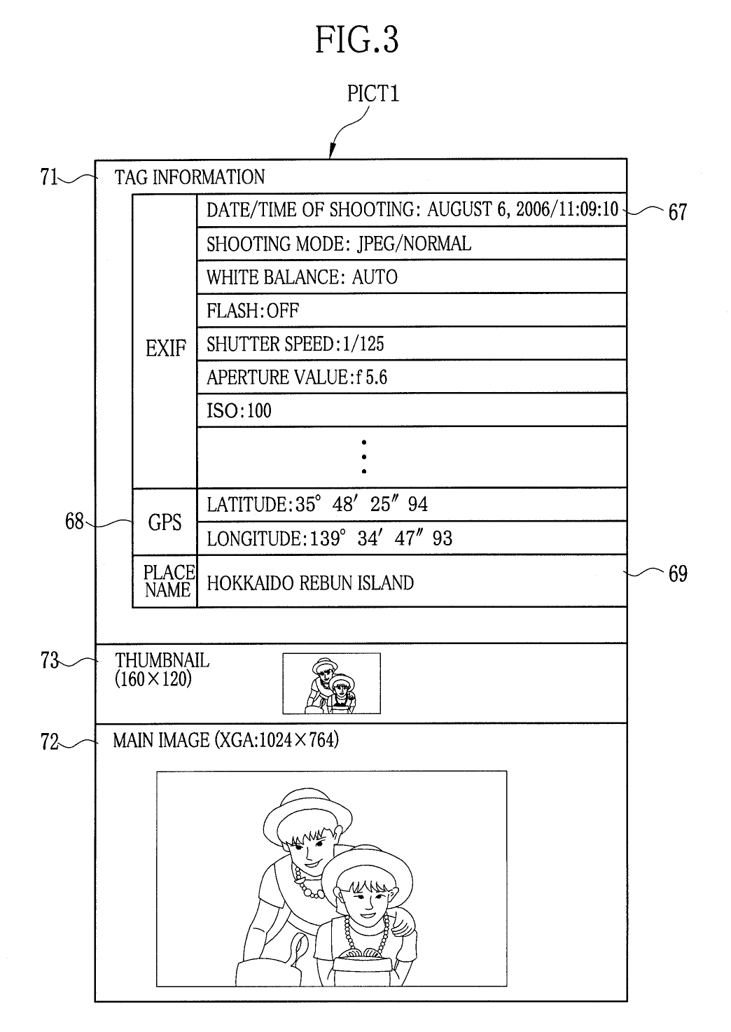

The CPU 30 refers to the LUT 60 when the shutter button 19 is fully pressed to record an image, and retrieves information on a place name from the LUT 60 in correspondence to the GPS information obtained from the GPS module 64 at that time. Then the CPU 30 records the date and time information from the clock member 65, the GPS information, and the place name information corresponding to the GPS information in an image file. As shown for example in FIG. 3, the image file PITC1 is an Exif format file consisting of a tag information 71, a main image 72 represented by image data compressed in the JPEG format, and a thumbnail image 73 obtained by reducing the main image 72, wherein the date and time information 67, the GPS information 68 and the place name information 69 are recorded as a fragment of the tag information 71. The image file is not limited to the Exif format, but may be any format insofar as tag information is attachable. Furthermore, the format of the image data is not limited to JPEG, but may be another format, such as TIFF (tagged image file format).

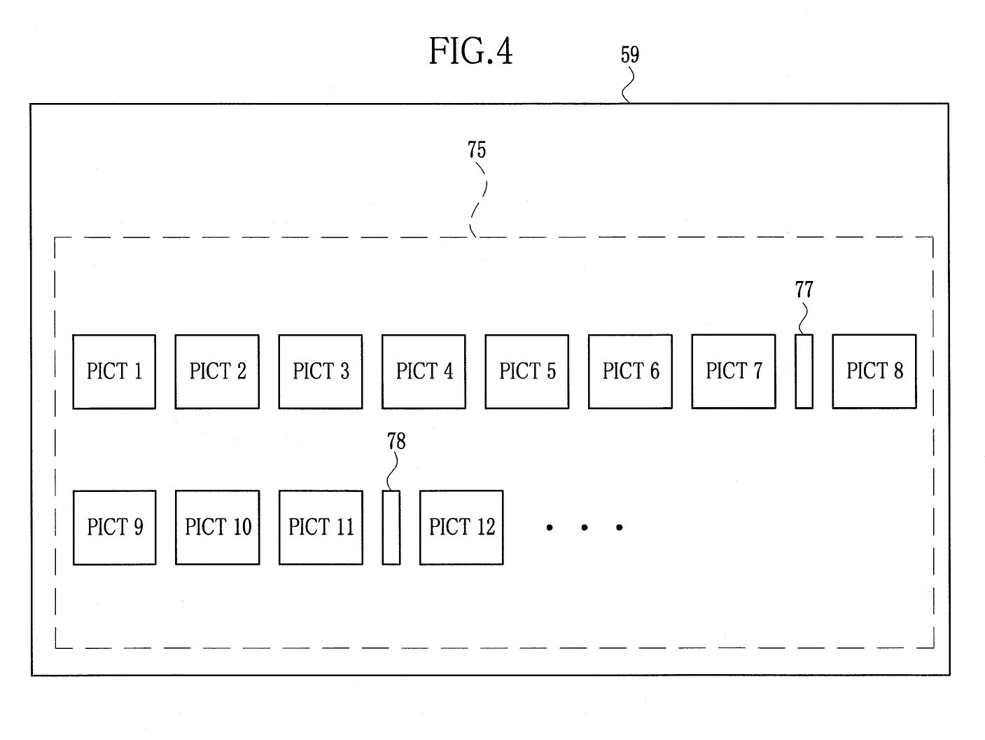

The image file PICT1 is recorded in a folder 75 that is previously formed in the memory card 59, as shown in FIG. 4. Thereafter, a second image file PICT2, a third image file PICT3 and so on are recorded time-sequentially in the folder 75. When the user presses the image sort-out button 16, e.g. after a seventh image file PICT7 is recorded in the illustrated embodiment, a first event delimiter file 77, is formed after the seventh image file PICT7. The user can press the image sort-out button 16 to delimit the events spontaneously.

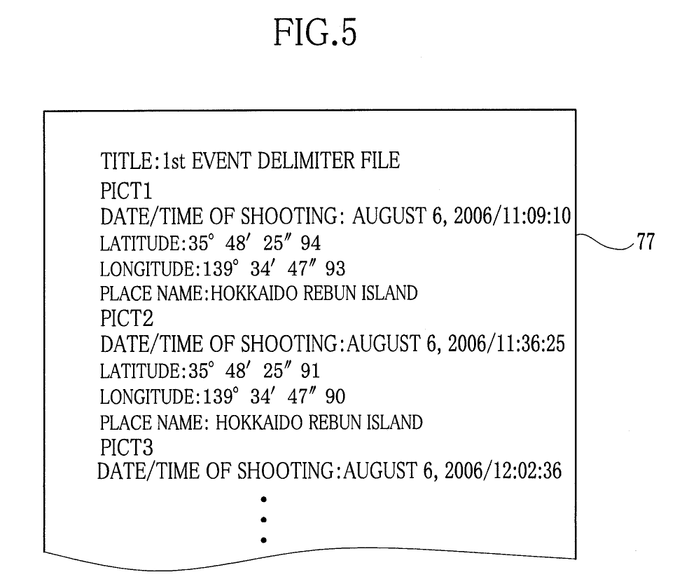

On forming an event delimiter file, it is checked if any event delimiter files are previously recorded in the folder 75. Since this is the first event delimiter file 77, no previous event delimiter file exits in the folder 75, so the date and time information 67, the GPS information 68 and the place name information 69 are read out from the tag information 71 of all the image files PICT1 to PICT7 recorded before the first event delimiter file 77, and the information 67 to 69 readout from these image files PICT1 to PICT7 are recorded in the first event delimiter file 77, as shown in FIG. 5.

After the first event delimiter file 77 is formed, image files PICT8, PICT9 and so on are recorded time-sequentially in the folder 75 in response to the full-pressing of the shutter button 19. In the illustrated embodiment, the image sort-out button 16 is pressed after the eleventh image file PICT11 is recorded, so a second event delimiter file 78 is formed after the eleventh image file PICT11 in the same way as the first event delimiter file 77.

On forming the second event delimiter file 78, it is first checked whether there are any event delimiter files in the folder 75 on the memory card 59. Since the first event delimiter file 77 is already recorded in the folder 75, the date and time information 67, the GPS information 68 and the place name information 69 are read out from the tag information 71 of those image files PICT8 to PICT11 which are recorded after the first event delimiter file 77, and the information 67 to 69 read out from these image files PICT8 to PICT11 are recorded in the second event delimiter file 78.

Thereafter, each time the image sort-out button 16 is pressed, another event delimiter file is seriatim formed in the folder 75 of the memory card 59. A series of image files separated from others by the event delimiter files are held to be the same group. Thus, the recorded image files are sorted into groups.

The images taken by the digital camera 10 may be reproduced and displayed on the LCD 55 of the digital camera 10 in a reproduction mode. Because the screen size of the LCD 55 is small, it is preferable to use a personal computer or the like as an image reproducing display device.

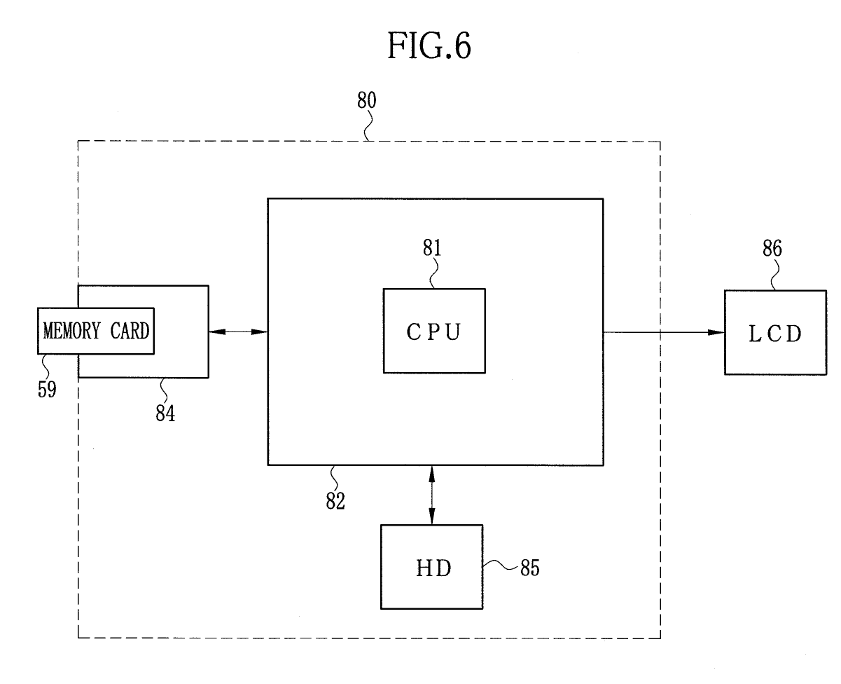

As shown in FIG. 6, a personal computer 80 has a mother board 82 that is mounted with a CPU 81, and a card slot 84, a hard disc (HD) 85 and an external LCD 86 are connected to the mother board 82. The HD 85 should be previously installed with a software program that is specific to the digital camera 10.

When the memory card 59 is taken out of the digital camera 10 and inserted into the card slot 84 of the PC 80, the specific software is automatically activated to search the folder 75 for the event delimiter files. Thereby, the first event delimiter file 77 is detected as the one that was formed the earliest among those event delimiter files which have not yet been used for displaying the images, and then the image files PICT1 to PICT7 taken before the first event delimiter file 77 are read out.

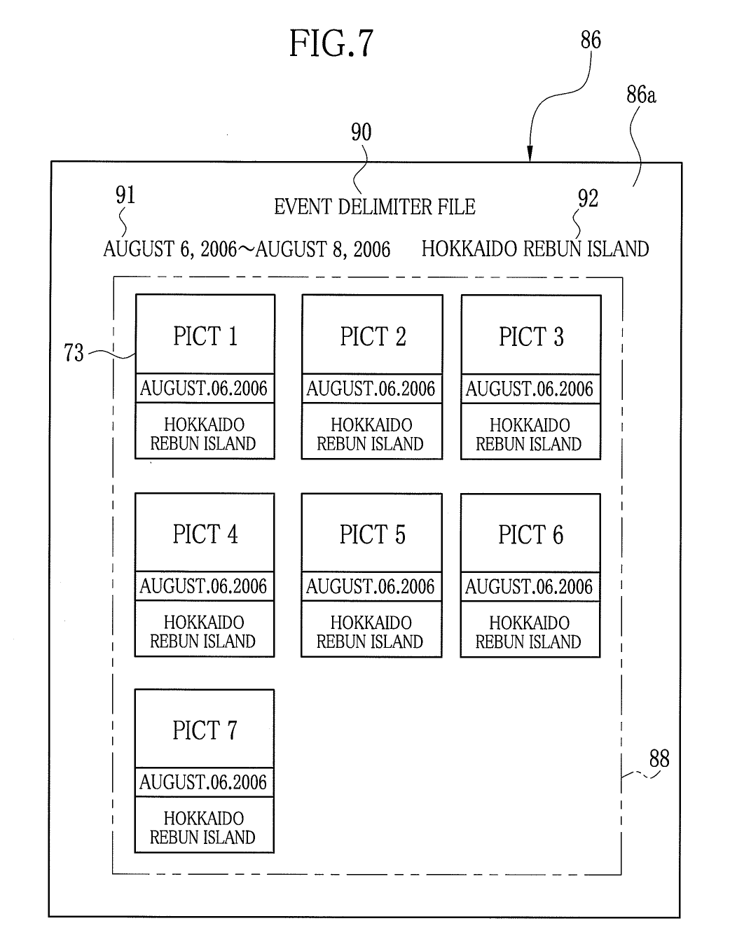

The CPU 81 calculates a minimum natural number N that satisfies a condition: N²≧the number of image files belonging to the same event or group. Since the number of image files PICT1 to PICT7 grouped by the first event delimiter file 77 is seven, the CPU 81 calculates that the number N=3. Then, the respective thumbnails 73 are read out from the image files PICT1 to PICT7, and displayed in a substantially-square rectangular area 88 on a screen 86a of the LCD 86, as shown by phantom lines in FIG. 7, wherein the thumbnails are arranged in a 3×3 matrix. Thus, all the images of one group corresponding to the first event are displayed together on the same screen.

If the size of each thumbnail 73 does not fit to display all the thumbnails 73 of the same group in the rectangular area 88, the size of each thumbnail 73 is changed so as to display all the thumbnails 73 neatly in the rectangular area 88. Below the individual thumbnails 73, the date and time of taking each image and its GPS information, e.g. its place name, are displayed.

Furthermore, a file name 90 “first event delimiter file” is read out from the first event delimiter file 77, and displayed at the topmost position of the screen 86a. Also the earliest date and the latest date are read out from the first event delimiter file 77, to display the time period 91 during which the images PICT1 to PICT7 were taken at the first event. In this example, “Aug. 6, 2006 to Aug. 8, 2006” is displayed as the time period 91. And an event title 92, the place name, “Hokkaido Rebun Island” in this example, is displayed beside the time period 91.

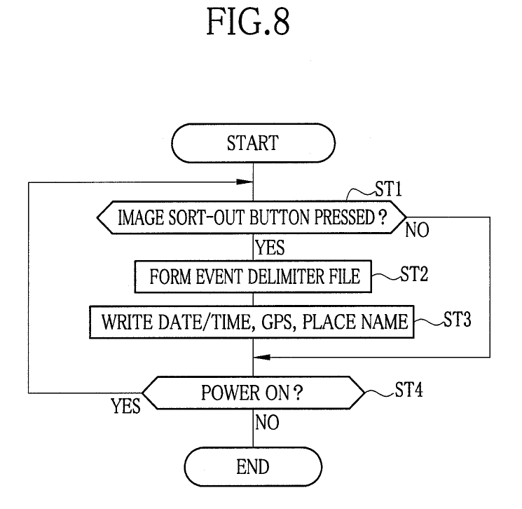

Next, an operation of the above embodiment will be described. For example, the user of the digital camera 10 trips to Rebun Island in Hokkaido, and takes images by the digital camera 10 there. After completing taking the images in the Rebun Island and before starting taking images in another place, e.g. in Rishiri Island in Hokkaido, the user presses the image sort-out button 16, as shown by step ST1 in the flowchart of FIG. 8. Then the first event delimiter file 77 is formed after the seventh image file PICT7 in the folder 75 of the memory card 59 (step ST2), the way as set forth above. Note that the user may presses the image sort-out button 16 at another timing to group the images spontaneously.

Thereafter, the date and time information 67, the GPS information 68 and the place name information 69 are read out from the tag information 71 of the respective image files PICT1 to PICT7 recorded before the first event delimiter file 77, and the information 67 to 69 read out from these image files PICT1 to PICT7 are recorded in the first event delimiter file 77 (ST3).

Until the digital camera 10 is powered off (ST4), an event delimiter file is formed each time the image sort-out button 16 is pressed. Thus, just by pressing the image sort-out button 16, images taken by the digital camera 10 are grouped into respective events, so the user can separate the images into arbitrary groups with ease. Since the event delimiter file is a text file, it saves the memory capacity of the memory card.

After the user makes a new folder other than the folder 75, images are recorded in the new folder, and event delimiter files are formed in the same way as described above, to separate the images into groups in the new folder.

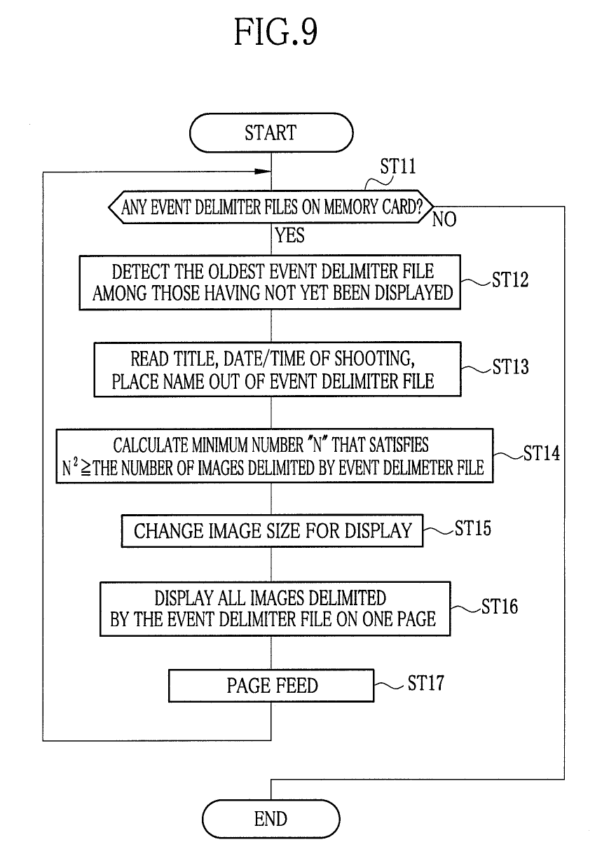

When the user takes the memory card 59 out of the digital camera 10, and inserts it into the card slot 84 of the PC 80, the specific software is activated and searches for any event delimiter file in the folder 75, as indicated by step ST11 in the flowchart of FIG. 9.

When some event delimiter files are found, the first event delimiter file 77 is detected as the oldest one that was formed the earliest among those event delimiter files which have not yet been used for displaying the thumbnails of the delimited images (ST12). Whether the event delimiter file has been used for displaying the images or not is recorded in a history file of the specific software, and detected with reference to the history file.

Next, the earliest and latest dates of taking the image files PICT1 to PICT7 and the name of the place where the image files PICT1 to PICT7 were taken are read out from the first event delimiter file 77, and the file name 90 “first event delimiter file”, the time period 91 “Aug. 6, 2006 to Aug. 8, 2006” and the place name “Hokkaido Rebun Island” are displayed in an upper position of the screen 86a of the LCD 86 (ST13).

Then, the image files PICT1 to PICT7 as recorded before the first event delimiter file 77 are detected, and a minimum natural number N that satisfies the condition: N²≧the number of the image files PICT1 to PICT7 is calculated (ST14). Because the number of the image files PICT1 to PICT7 is seven, the number N=3.

Then, the respective thumbnails 73 are read out from the image files PICT1 to PICT7, and if the size of each thumbnail 73 does not fit to display all the thumbnails 73 in the rectangular area 88, the size of each thumbnail 73 is changed (ST15), and the thumbnails 73 are displayed in a matrix in the rectangular area 88 (ST16).

Next, the screen 86a of the LCD 86 is fed to the next page (ST17), and it is checked whether there are any other event delimiter files than the first event delimiter file 77 in the folder 75 (ST11). In the present example, the second event delimiter file 78 is detected as the second oldest in the folder 75 (ST12), so the title, the date and time and the place name are read out from the second event delimiter file 78, and displayed in the upper area of the screen of the LCD 86 (ST13).

Then, those image files PICT8 to PICT11 are detected, which were recorded during a time period between the first and second event delimiter files 77 and 78. As there are four image files PICT8 to PICT11, the minimum number N is calculated to be 2 (ST14). So the thumbnails 74 read out from the image files PICT8 to PICT11 are displayed in a 2×2 matrix in the rectangular area 88 on the screen of the LCD 86 (ST16).

In the same way as above, the following event delimiter files, if any, are detected one after another in the sequence from the oldest, so that thumbnails of a series of image files delimited by a couple of successive event delimiter files are displayed in the substantially square area on a screen page of the LCD 86. Thus, the user can view all images shot in an individual event at once on the same page, and recognize the content of the event instantly.

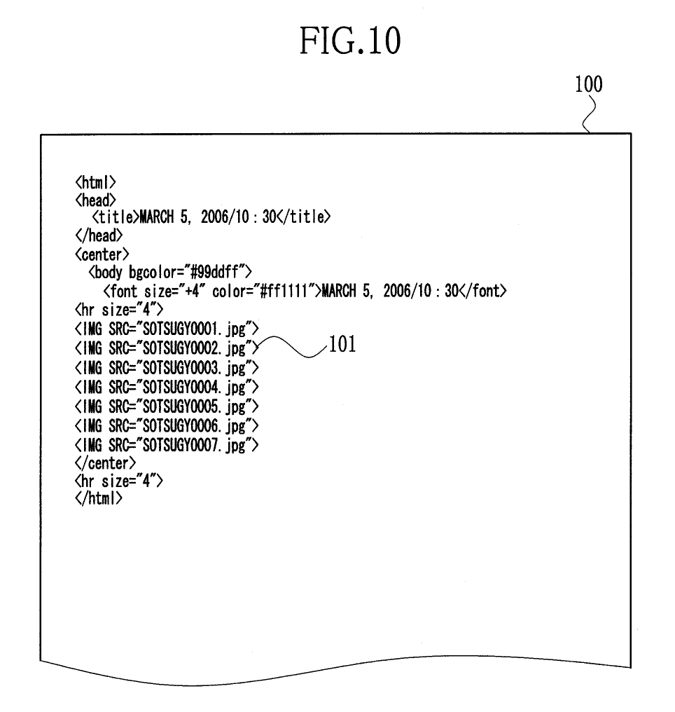

Although the event delimiter file is formed as a text file in the above embodiment, the event delimiter file may be an HTML file that is formed by writing tags in a plane text, for designating attributes of the text, as shown for example in FIG. 10. An HTML event delimiter file 100 has link information 101 indicating links to the image files belonging to the same group, in addition to the information on the title of the event delimited by this delimiter file 100. In the example shown in FIG. 10, the date and time at which the event delimiter file 100 was formed, e.g. “March 5, 2006/10:30”, is used as the event title. Owing to the link information 101, a group of images delimited by the event delimiter file 100 are displayed in a list on one page of the display screen, in the same way as illustrated in FIG. 7, just by setting the memory card in a personal computer and opening the event delimiter file 100 using the specific software. Therefore it is unnecessary to search for the image files of one group that is delimited by the event delimiter file 100. Although the date and time at which the event delimiter file 100 was formed is used as the event title, information on a geographic position at which the event delimiter file 100 was formed, e.g. the place name of the geographic position, is usable as the event title instead of or in addition to the date and time information.

Although the above embodiment previously forms a folder in a memory card, and records image files in the folder, it is possible to record image files directly on the memory card. In that case, event delimiter files are also recorded directly on the memory card.

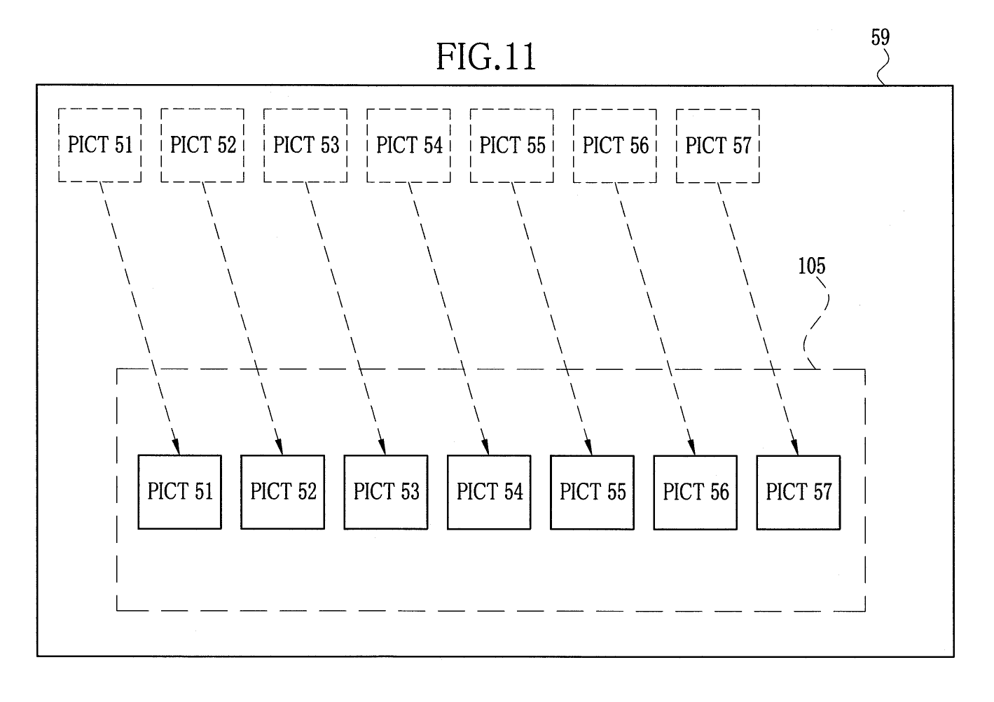

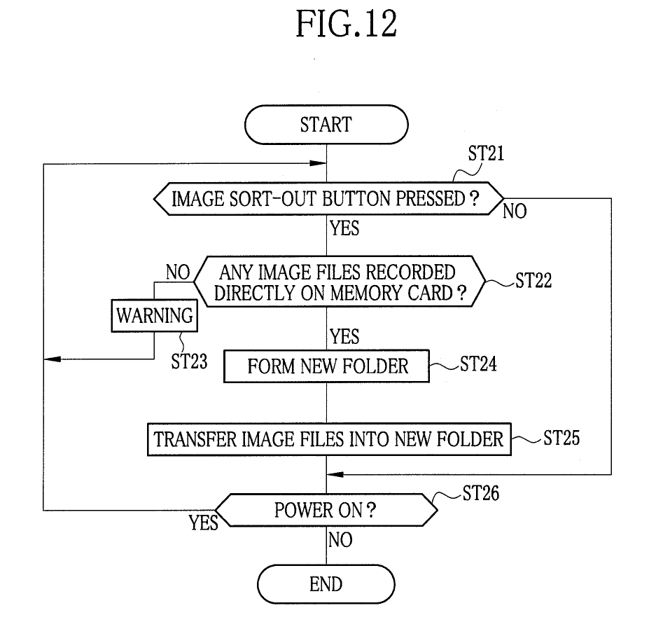

Now another embodiment of the present invention will be described with reference to FIGS. 11 and 12. Because the following embodiment may have the same outer appearance and the same internal structures as the above embodiment (see FIGS. 1, 2 and 6), the following embodiment will be described using the same reference numerals as the above embodiment, and omit the detail of the structure.

The digital camera according to the embodiment of FIGS. 11 and 12 usually records image files directly on a memory card 59 without forming a folder.

When an image sort-out button 16 is pressed (ST21), as shown in FIG. 12, a CPU 30 searches the memory card 59 for image files, to check whether there are any image files recorded directly on the memory card 59 (ST22). If no image file is recorded directly on the memory card 59, the CPU 30 warns the user of that fact by alarming or displaying a caution on an LCD 55 (ST23). In that case, the CPU 30 does not form a new folder in the memory card 59.

If some image files PICT51 to PICT57 have been directly recorded on the memory card 59 when the image sort-out button 16 is pressed, the CPU 30 forms a new folder 105 in the memory card 59, as shown in FIG. 11 (ST24). For example, the date and time of forming the folder 105 is used for its folder name. Then the CPU 30 transfers these image files PICT51 to PICT57 into the new folder 105 (ST25). Thereafter, so long as the digital camera is powered (ST26), images taken by the digital camera are directly recorded on the memory card 59, and each time the image sort-out button 16 is pressed (ST21), a folder is newly formed in the memory card 59, and those image files recorded previously on the memory card 59 but not yet stored in any folder are transferred into the new folder. In this way, image files of the same group are sorted into the same folder.

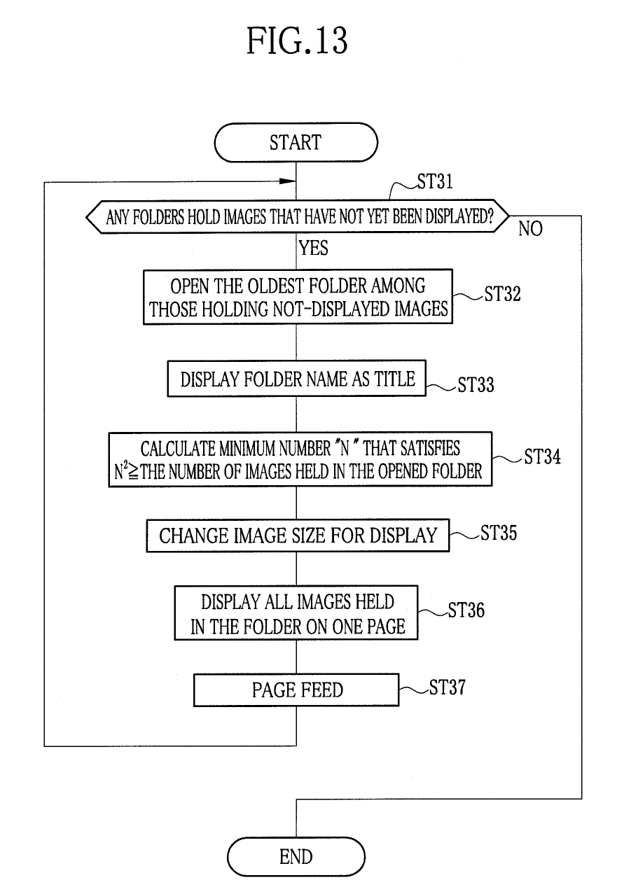

When the user wants to view the images sorted out in this way, the user sets the memory card 59 in a card slot 84 of a personal computer 80 (see FIG. 6). Then, as explained in the flowchart of FIG. 13, the specific software pre-installed in the PC 80 is automatically activated to check whether the memory card 59 stores those folders which hold images that have not yet been displayed (ST31). The names of such folders that hold already displayed images are recorded in an image display history of the specific software, so the image display history is referred to on determining whether the memory card 59 stores such folders that hold not-displayed images.

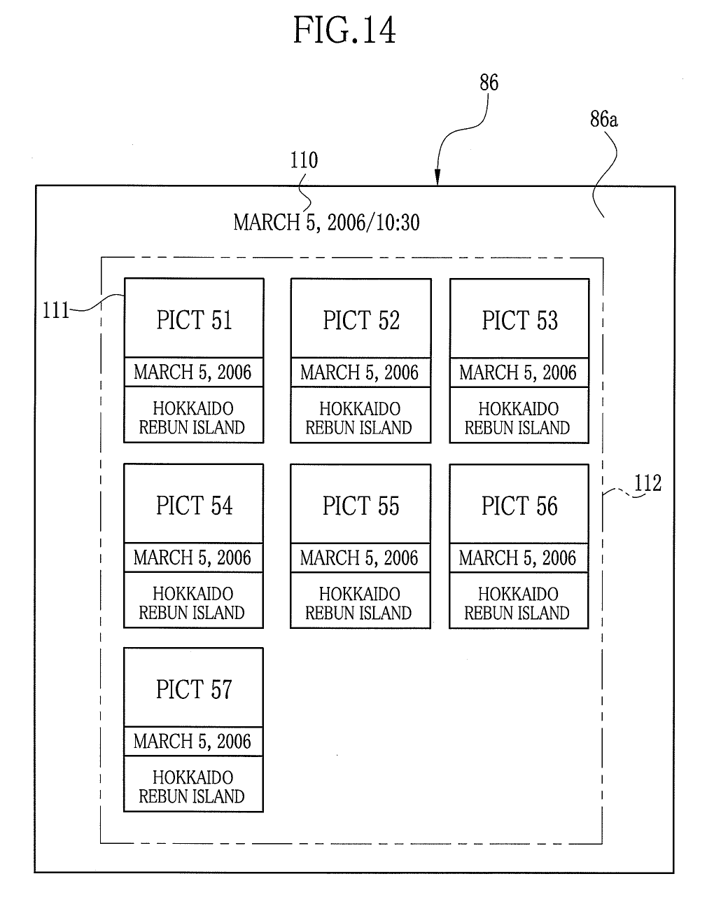

If there are many folders that hold not-displayed images, they are opened one after another from the oldest (ST32). In the present example, the folder 105 is opened. Then, the folder name of the holder 105, i.e. the date and time of forming the folder 105, is displayed as a page title 110 on a screen 86a of an LCD 86 (ST33), as shown in FIG. 14. On the other hand, the specific software calculates a minimum natural number N that satisfies the condition: N²≧the number of the image files PICT51 to PICT57 (ST34). Because the number of the image files PICT51 to PICT57 is seven, the number N=3.

Then, thumbnails 111 are read out from the respective image files PICT51 to PICT57, and if the size of each thumbnail 111 does not fit to display all the thumbnails 111 in a substantially-square rectangular area 112, the size of each thumbnail 111 is changed (ST35), and the thumbnails 111 are displayed in a matrix in the rectangular area 112 (ST36). Next, the screen 86a of the LCD 86 is fed to the next page (ST37), and the above-described steps ST31 to ST36 are cyclically executed.

Note that the date and time of forming the folder 105 is used for its folder name in the above embodiment, it is possible to use GPS information obtained from a GPS module 64, e.g. a place name, for the folder name. The folder name may consist of the date and time information and the GPS information.

It is also possible to form an HTML file outside or inside the folder 105 on the memory card 59 after the image files PICT51 to PICT57 are transferred into the folder 105, and record link information in the HTML file, to indicate that the image files PICT51 to PICT57 are in the same group. The user has only to set the memory card 59 in the personal computer 80, then the HTML files are opened using the specific software. The link information make it possible to display the thumbnails 111 of the image files PICT51 to PICT57 on the screen 86a of the LCD 86, without the need for reading out the thumbnails 111 from the image files PICT51 to PICT57 of the folder 105. It is preferable to record the title, the date and time, and the place name (GPS information) in the HTML file beside the link information.

Although the thumbnails are displayed in an N×N matrix (N=a natural number) so as to fit in a substantially square area on the display screen in the above embodiments, the present invention is not limited to this configuration. The thumbnails may be displayed in an elongated rectangular array. The image reproducing display device of the present invention is not limited to the personal computer, but may be a specific apparatus. In that case, it is preferable to make the image reproducing display device so small and light as to be portable conveniently.

Although the present invention has been described so for with respect to the preferred embodiments, the present invention is not to be limited to the above embodiments but, on the contrary, various modifications will be possible without departing from the scope of claims appended hereto.

What is claimed is:

1. An imaging apparatus that obtains an image signal from an optical image through an image sensor and converts the image signal into digital image data, said imaging apparatus comprising:
a device for recording the image data on a storage medium;
a device for forming a delimiter file in response to a predetermined operation on an operating member, said delimiter file indicating that those image data recorded before said predetermined operation are separated from image data recorded after said predetermined operation; and
a device for recording said delimiter file on said storage medium.

2. An imaging apparatus as recited in claim 1, wherein said delimiter file holds information on the date and time and/or a geographic position at which said delimiter file was formed.

3. An imaging apparatus as recited in claim 1, wherein said delimiter file is a text file.

4. An imaging apparatus as recited in claim 3, wherein said text file is an HTML file.

5. An imaging apparatus as recited in claim 4, wherein said delimiter file holds link information, and if there is not another delimiter file on said storage medium, said link information informs that all image data recorded before said predetermined operation belong to the same group, and if any other delimiter files are already recorded before said predetermined operation, said link information informs that image data recorded after the latest one of said already recorded delimiter files till said predetermined operation belong to the same group.

6. An imaging apparatus that obtains an image signal from an optical image through an image sensor and converts the image signal into digital image data, said imaging apparatus comprising:
a device for attaching tag information to the image data of each image to form an image file and recording the image file on a storage medium;
a device for forming a delimiter file in response to a predetermined operation on an operating member, said delimiter file indicating that those image files recorded before said predetermined operation are separated from ones recorded after said predetermined operation, wherein said tag information of all image files formed before said predetermined operation are recorded in said delimiter file if there is not another delimiter file on said storage medium, and that if other delimiter files are already recorded before said predetermined operation, said tag information of those image files formed after the latest one of said already recorded delimiter files till said predetermined operation are recorded in said delimiter file; and
a device for recording said delimiter file on said storage medium.

7. An imaging apparatus as recited in claim 6, wherein said tag information include information on the date and time and/or a geographic position at which the individual image file was formed.

8. An imaging apparatus as recited in claim 6, wherein said delimiter file is a text file.

9. An imaging apparatus as recited in claim 8, wherein said text file is an HTML file.

10. An imaging apparatus as recited in claim 9, wherein if there is not any other delimiter file on said storage medium, said delimiter file holds link information informing that all image files formed before said predetermined operation belong to the same group, and if other delimiter files are already recorded before said predetermined operation, said link information informs that image files formed after the latest one of said already recorded delimiter files till said predetermined operation belong to the same group.

11. An imaging apparatus as recited in claim 7, wherein the information on the geographic position include latitude and longitude of the geographic position and/or a place name determined by the latitude and longitude, and said imaging apparatus further comprises a GPS device for detecting latitude and longitude of a position at which said imaging apparatus is located.

12. An imaging apparatus that obtains an image signal from an optical image through an image sensor and converts the image signal into digital image data, said imaging apparatus comprising:
a device for recording the image data on a storage medium;
a device for forming a new folder in said storage medium in response to a predetermined operation on an operating member; and
a device for transferring those image data, which have been recorded on said storage medium but not yet been stored in any folder, into said new folder.

13. An imaging apparatus as recited in claim 12, further comprising a device for forming a text file in said storage medium and recording link information in said text file when said image data are transferred to said new folder, said link information informing that said image data transferred to said new folder belong to the same group.

14. An imaging apparatus as recited in claim 13, wherein said text file is an HTML file.

15. An image reproducing display device for reproducing images from image data recorded on a storage medium, to display the reproduced images on a screen, said image reproducing display device comprising:
a device for detecting if any delimiter files are recorded on said storage medium, said delimiter file indicating that those image data recorded in a time period before said delimiter file are separated from image data recorded after said delimiter file;
a device for sorting those image data recorded before a first recorded delimiter file into one group, and sorting those image data recorded in a time period between one delimiter file and a next delimiter file into one group if a number of said delimiter files are recorded on said storage medium; and
a device for displaying a list of images in a matrix based on the image data of the same group.

16. An image reproducing display device for reproducing images from image files recorded on a storage medium, to display the reproduced images on a screen, wherein said image file is formed by attaching tag information to image data of one image, said tag information including the date and time and/or a geographic position at which said image is obtained, said image reproducing display device comprising:
a device for detecting whether there are any delimiter files on said storage medium, wherein said delimiter file indicates that those image data recorded in a time period before said delimiter file are separated from image data recorded after said delimiter file, and said tag information of all image files recorded before said delimiter file are recorded in said delimiter file if said delimiter file is a first recorded one, or said tag information of those image files recorded in a time period from a preceding delimiter file to said delimiter file are recorded in said delimiter file if said delimiter file is recorded after the first; and
a device for displaying a list of images in a matrix on the basis of the image data of those image files whose tag information are recorded in the same delimiter file, as well as the date and time and/or the geographic position relating to the displayed images on the basis of said tag information recorded in said same delimiter file.

17. An image reproducing display device for reproducing images from image data recorded on a storage medium by an imaging apparatus that comprises a device for forming a new folder in said storage medium in response to a predetermined operation on an operating member, and a device for transferring those image data, which have been recorded on said storage medium but not yet been stored in any folder, into said new folder, said image reproducing display device comprising a device for displaying a list of images in a matrix on a screen on the basis of the image data stored in the same folder.

18. An image reproducing display device as recited in claim 17, wherein the size and the matrix arrangement of the images on the screen are determined by the number of images to be displayed in a list whose image data are stored in the same folder.
